(19) United States
(12) Patent Application Publication
(10) Pub. No.: US 2002/0129148 A1
(43) Pub. Date: Sep. 12, 2002

(54) Method and system for identifying traffic conditions

(75) Inventors: Peter B. Ritz, Meadowbrook, PA (US); Christopher J. Tilghman, Philadelphia, PA (US); Anna M. Spraycar, Philadelphia, PA (US)

Correspondence Address: Daniel H. Golub, 1701 Market Street, Philadelphia, PA, 19103, US

(73) Assignee: Peter Ritz

(21) Appl. No.: 10/142,199

(22) Filed: May 9, 2002

Related U.S. Application Data
(63) Continuation-in-part of application No. 09/974,711, filed on Oct. 10, 2001.
Application No. 09/974,711 is a continuation-in-part of application No. 09/971,115, filed on Oct. 4, 2001.
Application No. 09/971,115 is a continuation-in-part of application No. 09/971,321, filed on Oct. 4, 2001.
Application No. 09/971,321 is a continuation-in-part of application No. 09/971,369, filed on Oct. 4, 2001.
Application No. 09/971,369 is a continuation-in-part of application No. 09/971,093, filed on Oct. 4, 2001.
Application No. 09/971,369 is a continuation-in-part of application No. 09/236,176, filed on Jan. 25, 1999.
Application No. 09/971,369 is a continuation-in-part of application No. 09/310,355, filed on May 12, 1999, now abandoned.
Application No. 09/971,369 is a continuation-in-part of application No. 09/951,361, filed on Sep. 13, 2001.
(60) Provisional application No. 60/252,906, filed on Nov. 27, 2000.

(51) Int. Cl. G06F 15/16; G06F 15/173

(52) U.S. Cl. 709/225; 709/229

(57) ABSTRACT

Traffic conditions along a travel route are identified. Travel route identification information identifying the travel route is received and a unique identifier is assigned to the travel route. A request relating to a traffic condition along at least a portion of the travel route is received from a user. The request includes the unique identifier. Travel route traffic information for the travel route is analyzed. The traffic condition is identified based on the analysis. The user is informed of the traffic condition.

This application is a continuation-in-part of U.S. patent application Ser. No. 09/974,711, filed Oct. 10, 2001, which is a continuation-in-part of U.S. patent application Ser. Nos. 09/971,115; 09/971,321; 09/971,369; and 09/971,093, each filed on Oct. 4, 2001, and each of which claim priority to U.S. Provisional Application Serial No. 60/252,906, filed Nov. 27, 2000, and is a continuation-in-part of U.S. patent application Ser. Nos. 09/236,176, filed Jan. 25, 1999; 09/310,355, filed May 12, 1999; and 09/951,361, filed Sep. 13, 2001.

### FIELD OF THE INVENTION

The present invention relates to providing information about traffic conditions along a particular traffic route identified by an end user using a unique identification number.

### BACKGROUND OF THE INVENTION

A critical piece of information to commuters and other travelers is the traffic conditions along the route of intended travel. Traditionally, such information could be learned by listening to the radio or watching television. However, the traditional methods of learning about traffic conditions present numerous disadvantages. First, the traveler is able to learn this information only at the specific times it is broadcast on the radio or television. In addition, the user is subject to hearing the traffic conditions for all routes in the user's vicinity, including those routes that are irrelevant to the user's intended course of travel. This is time consuming and may be frustrating to the user. Further, the broadcast traffic condition information may not even include information about the specific routes in which the user is interested. Thus, there exists a need for a system and method that allows a user to obtain, at any time convenient to the user, traffic condition information relating to the user's intended route(s) of travel.

### SUMMARY OF THE INVENTION

The present invention is directed to a method and system for identifying a traffic condition along a travel route. Travel route identification information identifying the travel route is received. A unique identifier is assigned to the travel route. A request relating to a traffic condition along at least a portion of the travel route is received from a user. The request includes the unique identifier. Travel route traffic information for the travel route is analyzed. The traffic condition is identified based on the analysis. The user is informed of the traffic condition.

The present invention is also directed to a method and system for identifying a traffic condition along at least one travel route. End user identification information identifying a user is received. Travel route identification information identifying the at least one travel route is received. A unique identifier is assigned to the user based on the end user identification information and the travel route identification information. A request relating to a traffic condition along the at least one travel route is received from the user. The request includes the unique identifier. Travel route traffic information for the at least one travel route is analyzed. The traffic condition is identified based on the analysis. The user is informed of the traffic condition.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 is a diagram of an exemplary system, in accordance with a preferred embodiment of the present invention;

FIGS. 2-14 are exemplary user interfaces that may be used in accordance with a preferred embodiment of the present invention;

FIG. 15 is a flow chart illustrating a preferred embodiment of a method of the present invention; and

FIG. 16 is a flow chart illustrating a preferred embodiment of a method of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

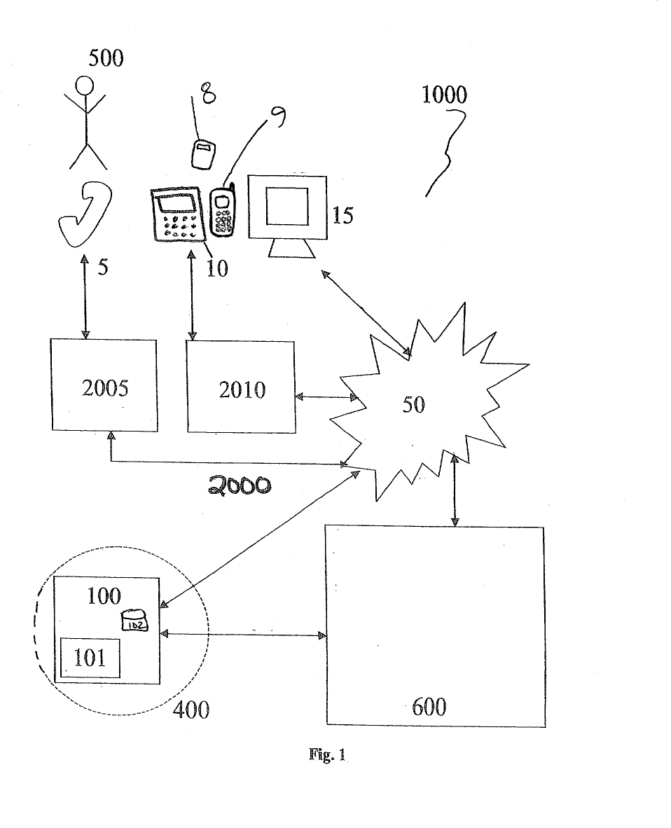

FIG. 1 illustrates a preferred embodiment of a system 1000 for carrying out the methods of the present invention. System 1000 includes a plurality of users 500, each with a device (which may be one of many types of communication devices). System 1000 also includes platform 100 and one or more providers 600. Providers 600 are organizations that gather and maintain information relating to traffic conditions along various travel routes, such as, for example, traffic.com and trafficmobile.com. In the preferred embodiment, platform 100 comprises multiple components that facilitate the identification and transfer of information between users 500 (and their associated devices) and providers 600. Platform 100 has a wide range of functionality, as described in more detail herein, but primarily functions as a switch in the preferred embodiment, obtaining travel route and traffic condition information from providers, maintaining such information and providing such information to users 500 as requested. Platform 100 includes a hub site 101 accessible via the Internet 50, which allows users 500 and providers 600 to interact with platform 100. Platform 100 also includes one or more databases 102 for storing information. Users 500, platform 100, and providers 600 may connect to each other through a variety of different types of links to form network 2000. In some embodiments, one or more of the links between these various entities is wireless.

Users 500 may employ a variety of different types of devices to input data, transmit data to platform 100 and obtain data from platform 100. For example, users 500 may contact platform 100 by telephone 5 and input the data by dialing or may speak the data into the handset. This input is transmitted though voice gateway 2005 to Internet 50 and then to a voice response unit at platform 100. Users 500 may also use, for example, a personal digital assistant 10, mobile phone 9, or RIM pager 8 and transmit data through wireless application protocol gateway 2010, to Internet 50, and then to platform 100. Alternatively, users 500 may use client 15 to input data, which are then transmitted through the Internet 50 to platform 100. Other means of inputting data and transmitting it to platform 100 will be known to those skilled in the art and are within the scope of the present invention. The particular device used by user 500 may dictate the functionality of system 1000 that will be enabled, as discussed in more detail below.

At least one interface 400 is disposed between platform 100 and the remainder of system 1000. Access to platform 100 is controlled through interfaces 400. In particular, for example, interfaces 400 monitor and provide security of communications between platform 100 and the remainder of the system 1000, as well as convert data transmitted to and from platform 100. Thus, interfaces 400 are the external boundary of platform 100. All interface calls to the platform 100, in the preferred embodiment, require credentials and authentication. Also, in cases in which privacy is a concern, encryption may be employed.

In the preferred embodiment, platform 100 performs a number of services, including a rendering service that enables output of data to user 500 regardless of the class of device being employed. This is accomplished by making adjustments to support specific protocols and by making allowances for the physical display geometry and input mechanism of a particular device, through a rendering interface. Thus, for example, users 500 will be able to receive output from system 1000 that is appropriate for the particular device being employed by users 500 (i.e., PCs (large devices), web enabled phones (small devices), or PDAs (medium devices)). In the preferred embodiment, providers 600 are responsible for supplying appropriate output for each class of device in order to take advantage of the rendering services of platform 100.

Platform 100 is comprised of a number of different components, in the preferred embodiment. Each component stores particular information and has certain functionality. The functionality supported by the components of platform 100 can be grouped into four main categories, in the preferred embodiment: (1) processing of data inputted by users, which includes authenticating data, devices, and users; receiving and encrypting/decrypting data, if necessary; and mapping inputted data to information desired by the user; (2) managing lists of travel routes and unique identifiers associated therewith; (3) administrating data associated with travel routes and associated information; and (4) monitoring events and usage, which includes monitoring event mechanisms and accessing input histories for each user 500 and each device.

In the preferred embodiment, platform 100 stores information about travel routes and unique identifiers associated therewith. Thus, a provider 600 may input and store at platform 100 information about various travel routes for which the provider 600 intends to provide traffic condition information, each of which is associated with a unique identifier. Groupings of travel routes inputted by each provider 600 may, in some embodiments, be further associated with a provider identifier. Platform 100 also maintains profile information associated with each user 500. The profile information includes, for example, the name of the user 500, as well as the user's home and business addresses, email address, telephone number and mobile phone number. The profile information of the user 500 also includes travel routes of interest to the user 500. The user 500 may designate customized groupings of travel routes of interest to the user 500, the groupings being assigned a unique identification number and stored in the profile of the user 500. The identification number assigned to each grouping may be based on, in the preferred embodiment, the telephone number of the user 500.

The information maintained on and functionality of platform 100 may be accessed via hub site 101, maintained on the Internet by platform 100. In a particular example, a route manager graphical user interface (“GUI”) can be used by providers 600 to input travel routes, have such routes assigned to unique identifiers, and assign contexts to the traffic condition information to be displayed to the user 500 (e.g., such as locale-specific display, display language, and output device channel, for example, small for mobile phone browser, medium for PDA browser, and large for PC browser). In addition to accessing platform 100 via hub site 101, users 500 may gain access to platform 100 through Connected™ window GUIs. Connected™ window GUIs represent one of a plurality of input points located at different web site locations on the network 2000. Thus, for example, a Connected™ window GUI may be found on any web site hosted on the Internet accessed via a personal computer and/or on the user interface of a mobile phone, PDA or other device connected to the Internet.

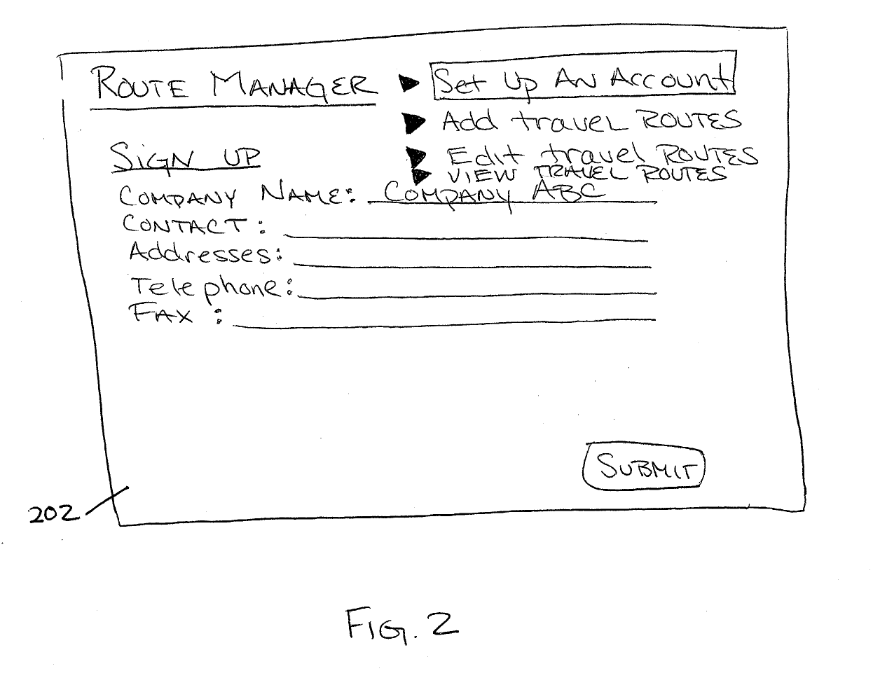

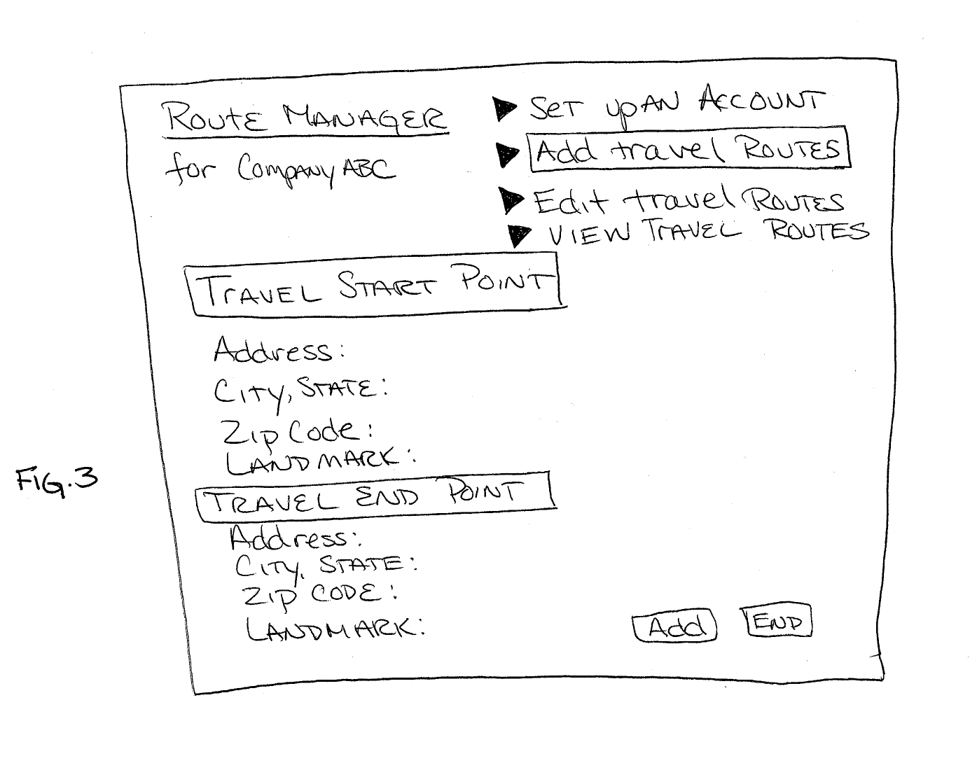

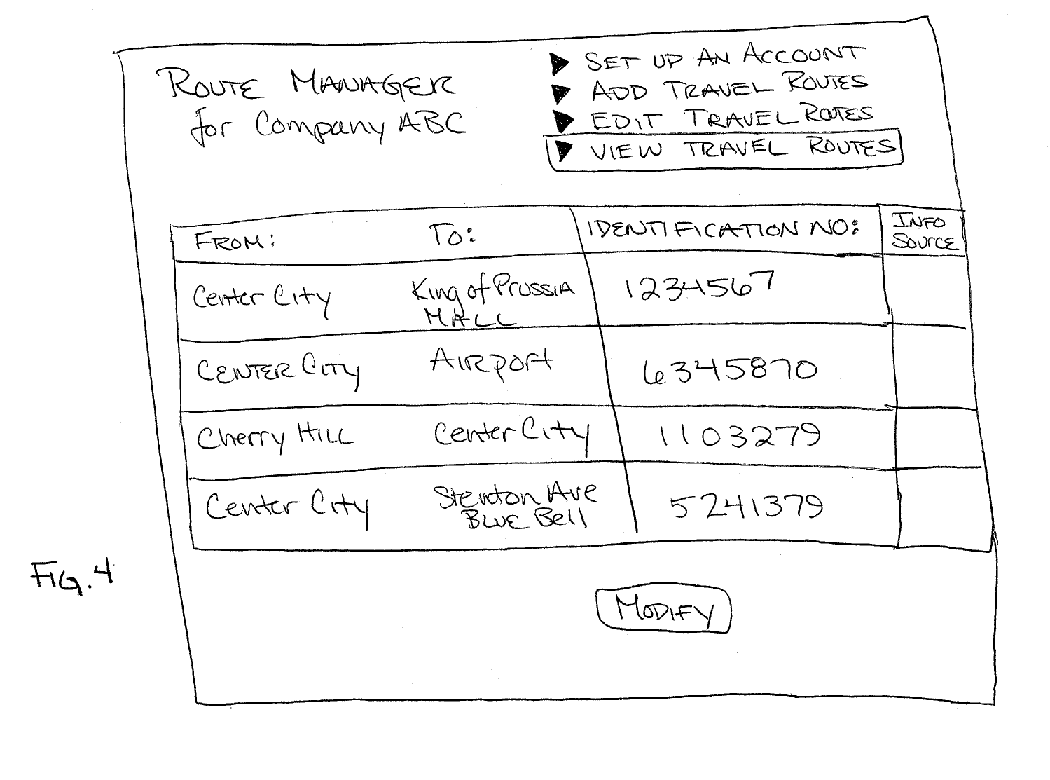

With reference to FIGS. 2-4, a series of exemplary interfaces used by providers 600 to enter travel routes into the system are illustrated. A provider 600 accesses platform 100 via the Internet using, for example, a route manger GUI 202, shown in FIG. 2. The provider 600 may then register with platform 100 by inputting information such as the company name, contact information, address, telephone number and facsimile number. Upon registering with platform 100, the provider 600 may, in some embodiments, be assigned a unique provider identifier. After submitting the information necessary to register with platform 100, the provider 600 may enter travel route information, as illustrated with reference to FIG. 3. The travel routes may be identified by the provider 600 in one or more of several different ways. For example, the provider 600 may select a start point and an end point for a travel route. The start point and end point may be identified by an address, a zip code, a well-known land mark or other ways that will be known to those skilled in the art. Upon submitting each travel route to platform 100, a unique identifier is associated with each travel route. Provider 600 may view their travel routes and associated unique identifiers, as illustrated in FIG. 4. In some embodiments of the present invention, the travel route is identified using a compound number. One portion of the compound number corresponds to the provider 600 and a second portion of the compound number corresponds to the travel route. In still other embodiments, provider 600 may associate a parameter name with the travel route.

Each travel route entered by provider 600 may then be associated (using, e.g., database(s) 102) with a source of traffic condition information. For example, each travel route may be associated with a URL that includes a specified parameter identifying information that is retrieved from a database and displayed to the user for the specified travel route.

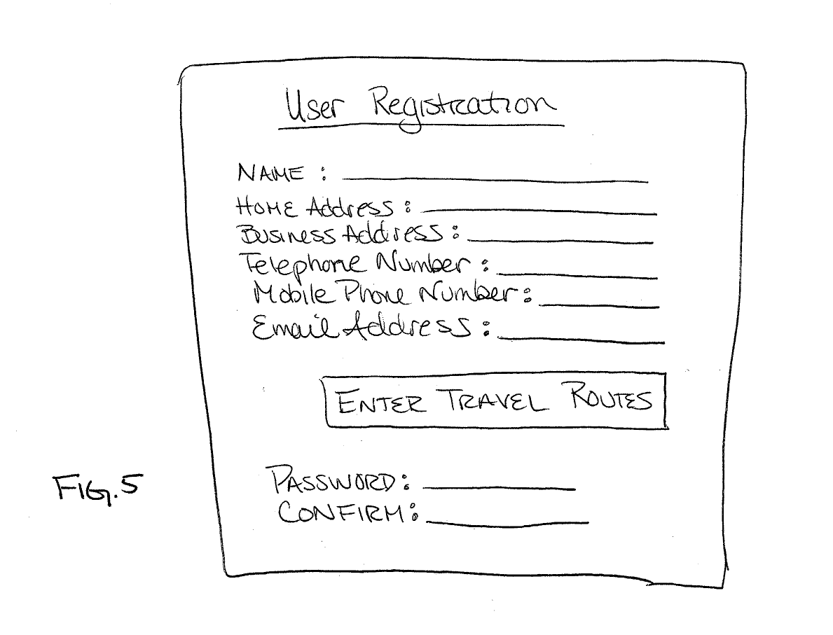

An exemplary user experience employing the system and methods of the present invention is illustrated with reference to FIGS. 5-14. In the preferred embodiment, the user 500 approaches a website hosted by the platform 100 (e.g., via hub site 101) and registers with the inventive service. With reference to FIG. 5, the user 500 may be asked to provide basic information such as the user's name, home address, business address, telephone number, mobile phone number and e-mail address. The user 500 may also be asked to select and confirm a password that will allow the user 500 to gain access to the inventive system. The user 500 may be required to pay for use of the inventive service (e.g., a monthly fee to support a certain number of identified routes).

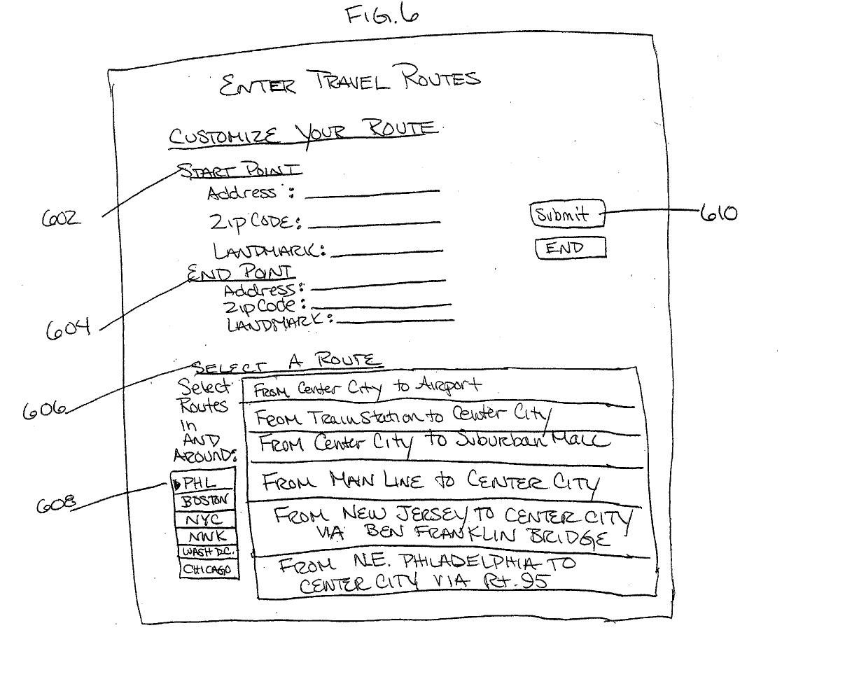

The user 500 may then identify the travel routes in which the end user is interested, which will form a part of the user's route profile. With reference to FIG. 6, the travel routes may be identified by the user 500 in one or more of several different ways. For example, the user 500 may select a start point 602 and an end point 604 for a travel route. The start point 602 and end point 604 may be identified by an address, a zip code, a well-known land mark or other ways that will be known to those skilled in the art. Alternatively, the user 500 may identify a travel route from one of several predetermined travel routes 606 displayed to the user. The particular travel routes displayed for the user may be selected by platform 100 based on information in the user's profile. For example, the travel routes displayed may be selected based on the user's home address and/or business address. Alternatively, the travel routes displayed may be based some other locale 608 chosen by the user. It will be appreciated that travel routes may be added or removed by the user 500 at any point, not only during the registration process.

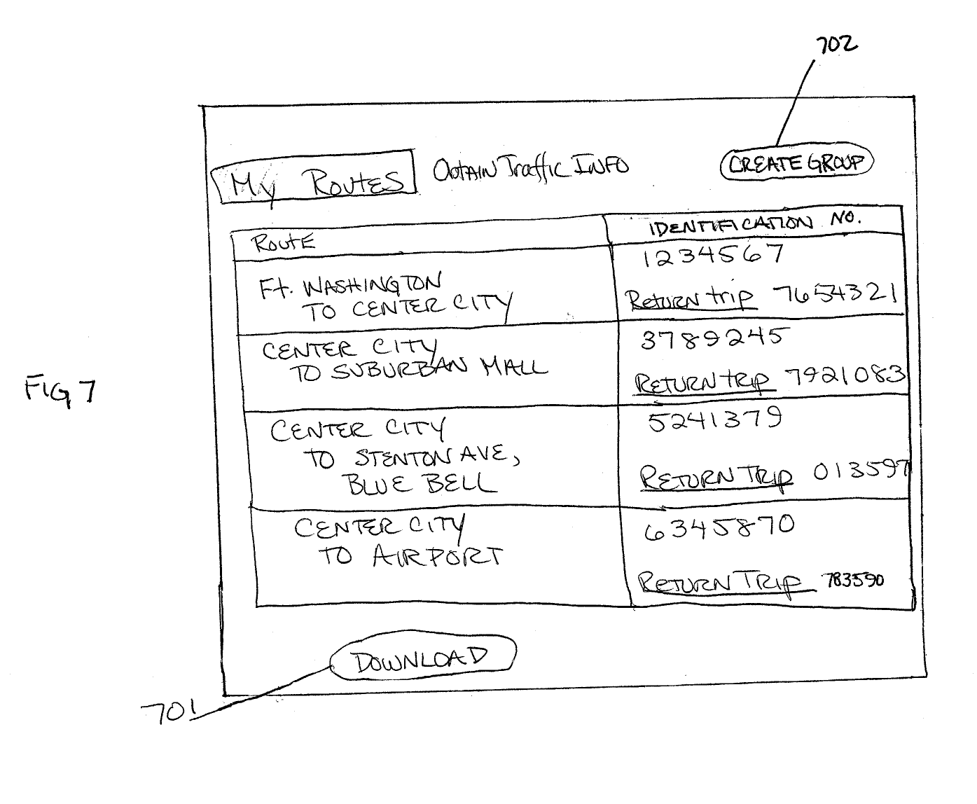

Upon the user's identification of desired travel route(s), the user 500 may indicate his desire to submit the same to platform 100 by selecting the “Submit” button 610. Data representing the indicated travel routes is then received at platform 100 and stored in one or more database(s) 102 along with the user's profile. Platform 100 assigns to each travel route a unique identification number and, in the preferred embodiment, a second unique identification number associated with travel along the travel route in the opposite direction. With reference to FIG. 7, the user is then informed of the unique identification number assigned to each travel route. The user may download 701 this information to a portable device (such as a mobile telephone or PDA) for ease of reference at a later time.

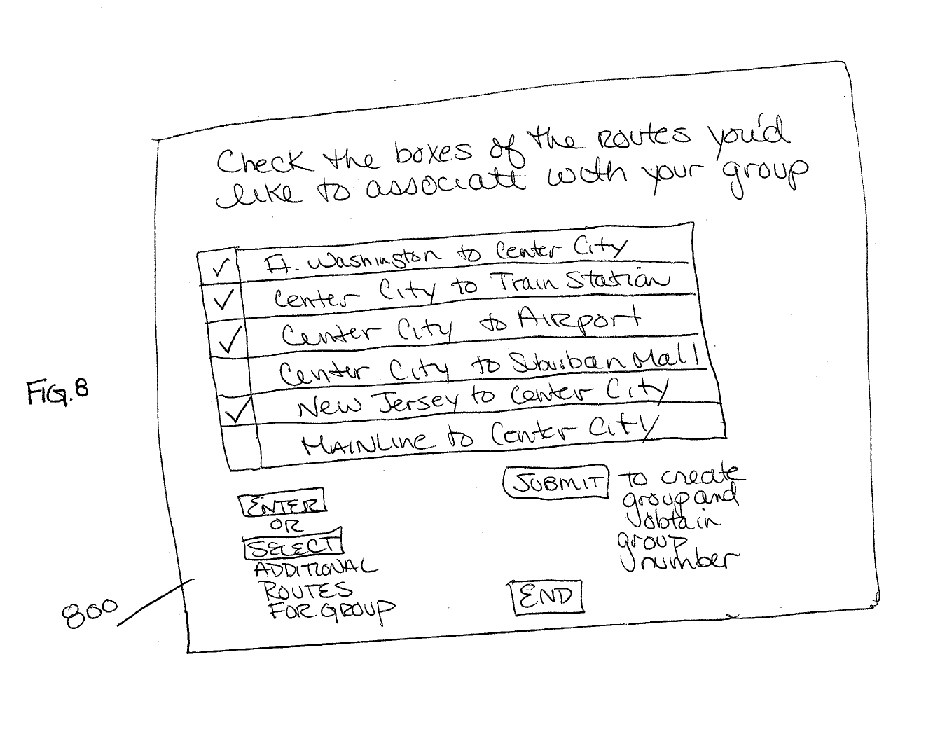

The user 500 may also create groups of travel routes. For example, with reference to FIG. 7, upon selecting “Create Group” button 702, the user will be presented with screen 800 of FIG. 8. Using screen 800, the user 500 may indicate the travel routes to be included in the user's customized group of routes. Upon submitting the user's choices, the choices are submitted to platform 100, stored as a group and assigned a unique group identification number. The group identification number may, in the preferred embodiment, be associated with some uniquely identifying user characteristic, such as the user's telephone number.

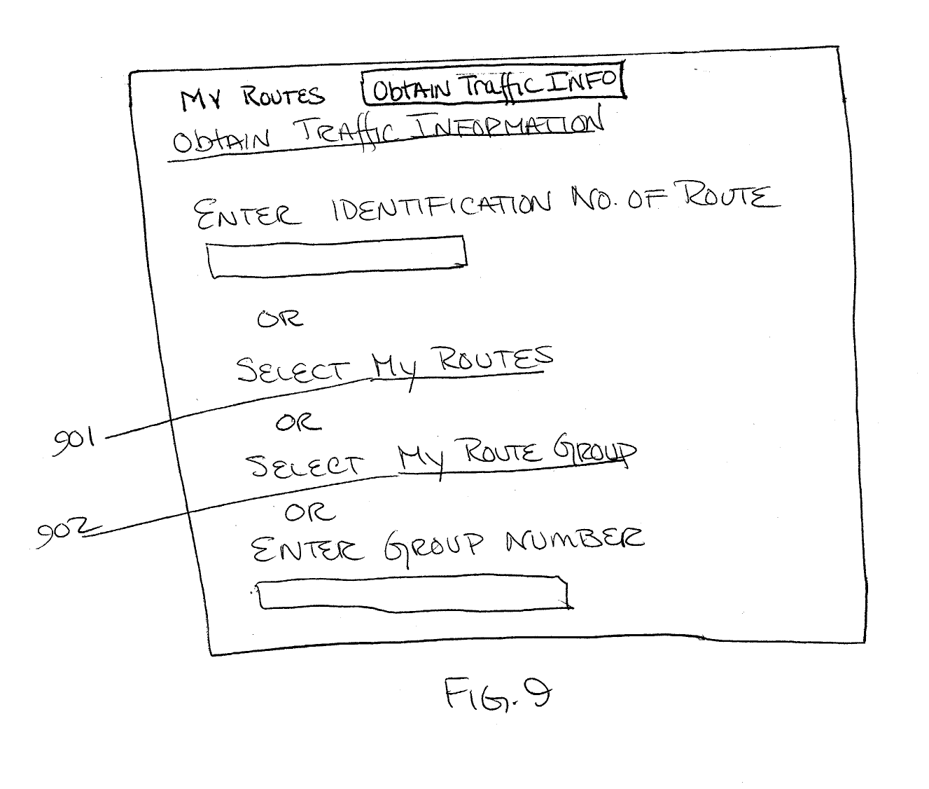

The user 500 may then access information regarding the selected travel routes prior to or during the user's travel experience. For example, in one embodiment, with reference to FIG. 9, the user 500 may navigate to platform 100 via the Internet and select the route(s) for which the user 500 is interested in obtaining traffic information. This can be accomplished in any one of several ways. For example, the user 500 may input the unique identification number corresponding to the route or group of routes in which the user is interested, and obtain information on the traffic conditions along the route(s). Alternatively, the user 500 may select a route or routes of interest by selecting “My Routes” button 901 or “My Route Group” button 902, which will then display to the user 500 for selection the unique identification numbers for their previously selected route(s).

Upon submitting the request comprising the unique identification number/unique group identification number to platform 100, platform 100 consults databases 102 to identify the location of traffic condition information corresponding to the travel route associated with the unique identification number. For example, platform 100 may analyze the travel route associated with the unique identification number specified by the user and identify individual segments of the route (e.g., roadways), if applicable. Then, for each route or route segment identified, platform 100 consults database(s) 102 to identify the corresponding route for which platform 100 has access to traffic information from providers 600. Platform then identifies the location of the traffic information associated with the route, and connects the user to the traffic information using the location.

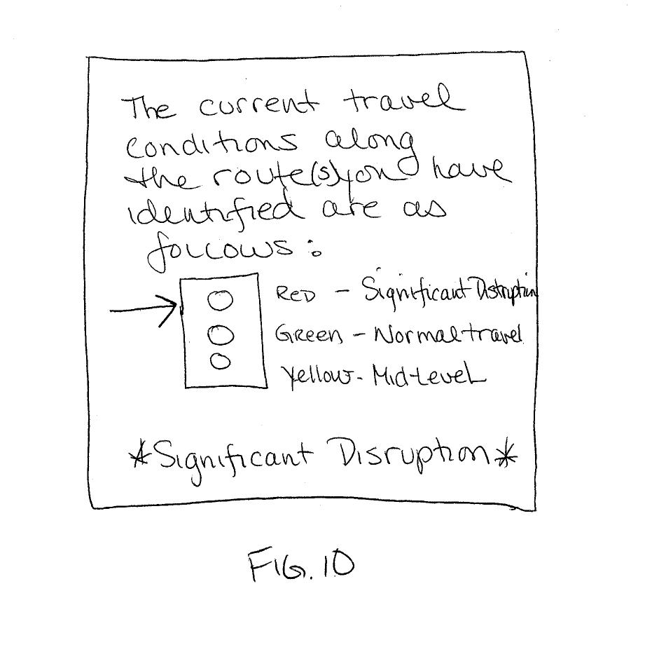

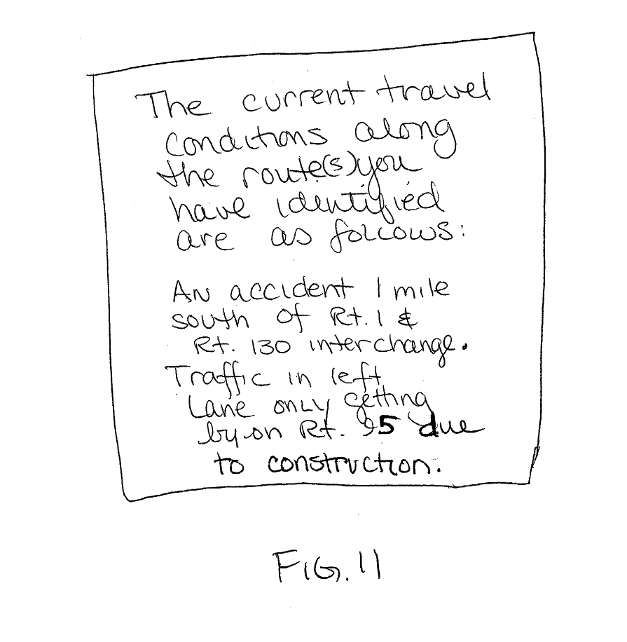

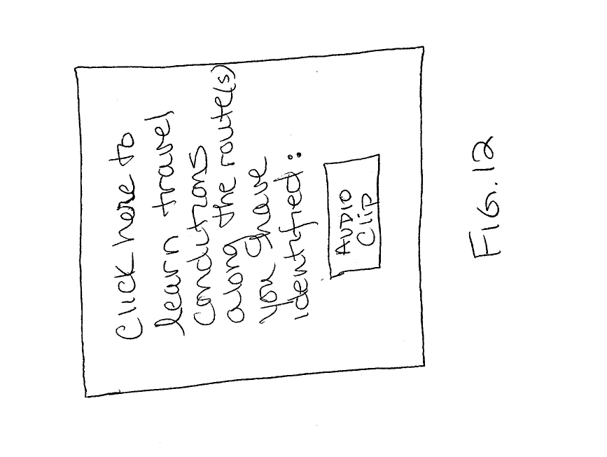

Information regarding the current traffic conditions along the identified route(s) is then displayed for the user 500. Such information may include a general indication of travel conditions along the route, such as a green light indicating normal travel conditions, a red light indicating a significant disruption in traffic, or a yellow light indicating some mid-level intensity disruption in travel conditions, as shown in FIG. 10. The information regarding the current travel conditions along the route(s) may include specific messages, such as the location of an accident or construction and resulting closed lanes; the mileage of back-ups on a given roadway; identification of events leading to congestion in certain areas; and road closings, by way of example, as shown in FIG. 11. The information presented to the user 500 may be visual (as shown in FIGS. 10 and 11) or may be presented by way of an audio clip, as illustrated in FIG. 12. In the preferred embodiment, the travel condition reported to the user 500 is reasonably contemporaneous with the actual happening of the condition, depending on the availability of such information from providers 600.

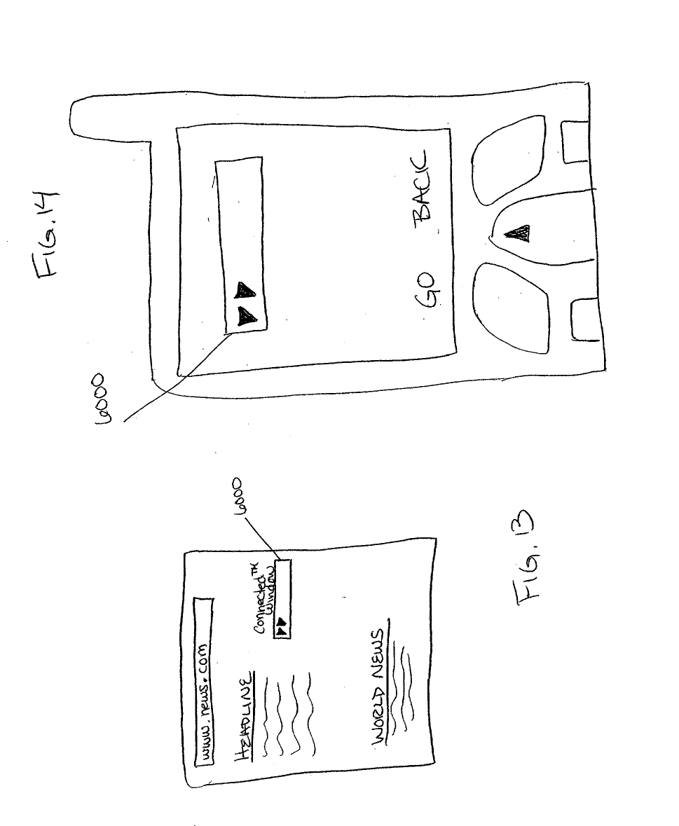

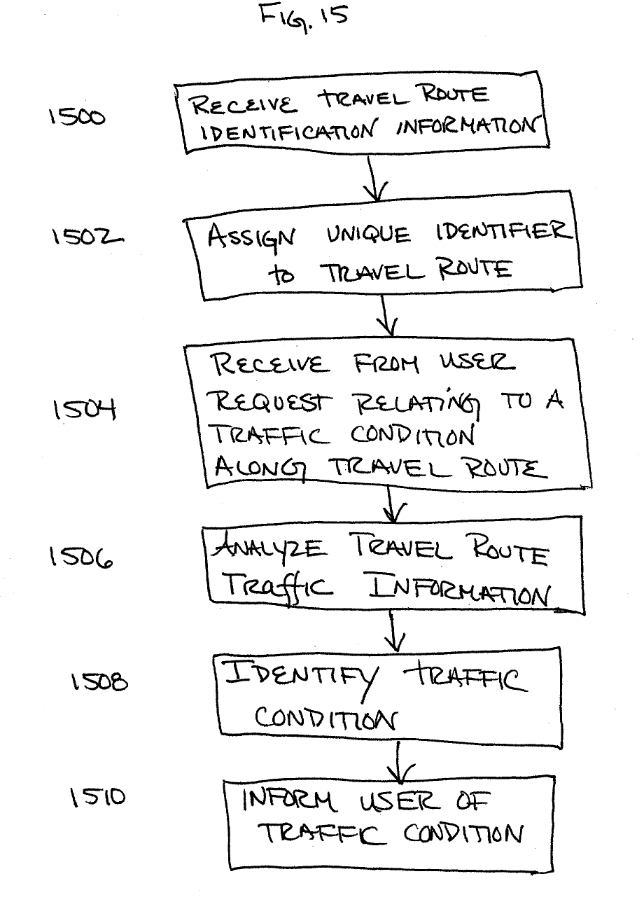

By way of further example, the user may obtain information on current travel conditions along a particular route(s) by entering the unique identification number corresponding to the route(s) using a Connected™ window. For example, as shown in FIGS. 13 and 14, respectively, a Connected™ window 6000 may be found on any web site on network 2000 by navigating to that web site using a personal computer or other Internet-enabled device, such as a mobile phone. The travel conditions are determined and returned to the user as described above with reference to FIGS. 10, 11 and 12.

In another embodiment, the user 500 contacts platform 100 via telephone 5 (of FIG. 1). In this embodiment, the user 500 first calls a predetermined number to be connected to platform 100. The user 500 then inputs the unique identification number corresponding to the route or group of routes in which the user is interested by speaking the number into the receiver or typing the number using the telephone keypad. In the case in which the user speaks the number into the receiver, a VRU at platform 100 converts the voice signal into data representing the identification number. Using the identification number, the current travel conditions along the desired route(s) are identified. An audio clip containing information related to the travel conditions is then reported to the user 500 via the telephone 5. As stated elsewhere above, the traffic condition information may be generalized (i.e., “Travel along this route is OK”) or more specific (i.e., “A major accident has occurred in Anywhere Town near the intersection of Route 1 and Smith Street. Only one lane of traffic is getting by in either direction.”).

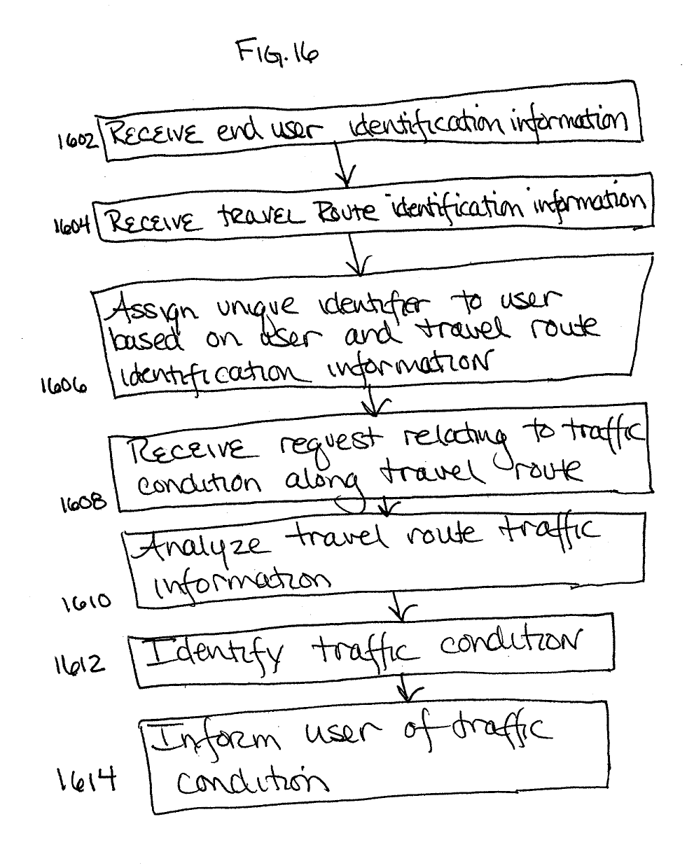

With reference to FIG. 15, a method of identifying a traffic condition along a travel route is illustrated. In step 1500, travel route identification information identifying the travel route is received. In step 1502, a unique identifier is assigned to the travel route. In step 1504, a request, that includes the unique identifier, relating to a traffic condition along at least a portion of the travel route is received from a user. Travel route traffic information is analyzed for the travel route, in step 1506. The traffic condition is identified based on the analysis, in step 1508. In step 1510, the user is informed of the traffic condition.

With reference to FIG. 16, a method for identifying a traffic condition along at least one travel route is illustrated. End user identification information identifying a user is received in step 1602. Travel route identification information identifying the at least one travel route is received, in step 1604. A unique identifier is assigned to the user based on the end user identification information and the travel route identification information, in step 1606. In step 1608, a request (including the unique identifier) relating to a traffic condition along the travel route is received. In step 1610, travel route traffic information for the travel route is analyzed. In step 1612, the traffic condition is identified based on the analysis. In step 1614, the user is informed of the traffic condition.

While in some embodiments the current traffic condition information is simply passed to the user 500 from the platform 100 as it is obtained from providers 600, in other embodiments the information is rendered by platform 100 into the format that is suitable for the device used by the end user to request the information (such as, for example, a voice phone, a web phone, PDA, personal computer).

The present invention may be embodied in other specific forms without departing from the spirit or essential attributes of the invention. Accordingly, reference should be made to the appended claims, rather than the foregoing specification, as indicating the scope of the invention.

What is claimed is:

1. A method for identifying a traffic condition along a travel route, the method comprising:
receiving travel route identification information identifying the travel route;
assigning a unique identifier to the travel route;
receiving from a user a request relating to a traffic condition along at least a portion of the travel route, wherein the request comprises the unique identifier;
analyzing travel route traffic information for the travel route;
identifying the traffic condition based on the analysis; and
informing the user of the traffic condition.

2. The method of claim 1 wherein the travel route identification information comprises a start point and an end point of the travel route.

3. The method of claim 1 wherein the travel route identification information comprises a user selection from a predetermined list of travel routes.

4. The method of claim 1 wherein the request is received from the user employing at least one of a telephone, a RIM device, and a personal digital assistant.

5. The method of claim 4 wherein the request is received over a global communications network.

6. A method for identifying a traffic condition along at least one travel route, the method comprising:
receiving end user identification information identifying a user;
receiving travel route identification information identifying the at least one travel route;
assigning a unique identifier to the user based on the end user identification information and the travel route identification information;
receiving from the user a request relating to a traffic condition along the at least one travel route, wherein the request comprises the unique identifier;
analyzing travel route traffic information for the at least one travel route;
identifying the traffic condition based on the analysis; and
informing the user of the traffic condition.

7. The method of claim 6 wherein the travel route identification information comprises a user selection from a predetermined list of travel routes.

8. A system for identifying a traffic condition along a travel route comprising:
one or more servers for receiving travel route identification information identifying the travel route; assigning a unique identifier to the travel route; receiving from a user a request relating to a traffic condition along at least a portion of the travel route, wherein the request comprises the unique identifier; analyzing travel route traffic information for the travel route; identifying the traffic condition based on the analysis; and informing the user of the traffic condition.

9. A system for identifying a traffic condition along at least one travel route comprising:
one or more servers for receiving end user identification information identifying a user; receiving travel route identification information identifying the at least one travel route; assigning a unique identifier to the user based on the end user identification information and the travel route identification information; receiving from the user a request relating to a traffic condition along the at least one travel route, wherein the request comprises the unique identifier; analyzing travel route traffic information for the at least one travel route; identifying the traffic condition based on the analysis; and informing the user of the traffic condition.
